(19) United States
(12) Patent Application Publication
(10) Pub. No.: US 2021/0373189 A1
(43) Pub. Date: Dec. 2, 2021

(54) DRILLING UNIT ENERGY SOURCE FOR PIEZOELECTRIC EXPLORATION

(71) Applicant: Datacloud International, Inc., Seattle, WA (US)

(72) Inventors: Daniel Palmer, Santa Barbara, CA (US); James Rector, Oakland, CA (US); Michael Wilt, Walnut Creek, CA (US)

(21) Appl. No.: 17/174,645

(22) Filed: Feb. 12, 2021

Related U.S. Application Data
(63) Continuation of application No. PCT/US2019/046382, filed on Aug. 13, 2019.
(60) Provisional application No. 62/718,163, filed on Aug. 13, 2018.

(51) Int. Cl. G01V 3/28; G01V 3/34

(52) U.S. Cl. CPC G01V 3/28; G01V 2210/1216; G01V 3/34

(57) ABSTRACT

In addition to drilling operations a hard rock drill rig is used to induce seismic energy into subsurface rock formations. In quartz rich rock the seismic energy will partially convert to electrical energy thereby allowing for the prospecting of ore-bearing quartz veins. Seismic energy and electric energy are detected by a sensor array. The electric energy is used to infer the presence of piezoelectric materials in the rock formations, and such materials are mapped using the detected seismic energy and electric energy.

### CROSS REFERENCE TO RELATED APPLICATIONS

Continuation of International Application No. PCT/US2019/046382 filed Aug. 13, 2019. Priority is claimed from U.S. Provisional Application No. 62/718,163 filed on Aug. 13, 2018. Both the foregoing applications are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of piezoelectric energy sources and detectors. More specifically, the disclosure relates to the use of piezoelectric technology to subsurface exploration for minerals and other useful substances.

Piezoelectric properties of materials were initially discovered about 1850. Piezoelectric energy sources and energy detectors have been used in a variety of applications, including mineral exploration (Cady, 1946). Russian entities have performed mineral exploration using piezoelectric technology for a considerable period of time, with one methodology being published in 1965 (Volarich et al., 1965) and a number of case histories published (e.g., Neistadt et. al., 1974, Volarich and Sobolov, 1969). The published techniques were principally used to track ore-bearing quartz veins in the search for sulfide minerals and gold.

Patents (inventor certificates) for the surface and mine-based piezoelectric exploration methods were published in the 1960's in the former Soviet Union, and although the basic physics of the process remains the same, signal generating and acquisition technology, signal processing methods and equipment have changed substantially.

Piezoelectricity is part of a broader of class of phenomena termed electrokinetics whereby an electrical charge and/or current is generated as a result of an applied mechanical stress to a material. The technologies include:

Flow Electrokinetics—whereby an electric current is generated as a result of heat flow, or fluid flow through a porous medium;

Electroseismicity—wherein an electric field is generated by mechanical interaction with a medium, through a traveling seismic wave; and

Piezoelectricity, wherein a charge is generated as a result of a mechanical stress, e.g., a hammer blow or explosive detonation. In the latter t case the effect is more apparent in certain crystalline materials such as quartz. The piezoelectric effect arises when the crystal structure is mechanically strained or broken, thereby displacing charges within the crystal lattice and creating an electrical potential across the crystalline structure, which generates an electrical field in the adjoining media.

As a mechanical impulse propagates through the ground it will emit an electromagnetic field, although this is very small except in piezoelectric (PZ) materials (e.g., quartz). When the seismic wave interacts with a boundary where seismic and/or piezoelectric properties change across the boundary, an electrical source (dipole) is induced at the interface and an EM field is generated The corresponding EM field may be detected using a nearby array of sensors, thereby enabling determination of the location of the interface, e.g., a quartz vein. A quartz vein may therefore be located from the arrival of electrical field signals, if the seismic velocity field of the subsurface is known. ??? this is not what we are patenting

Relation of Mechanical and Electrical Signals

Existing PZ theory, supported by laboratory measurements (references), suggests that the induced electrical charge (q) is proportional to the stress (τ) applied through a material having PZ constant (δ).

q=δτ (1)

The electrical current (I) is given by the time variation in mechanical stress, e.g., as caused by a moving hammer coming to rest.

I=dq/dt=δdτ/dtI=dq/dt=δdτ/dt (2)

The above relationship suggests that the electrical potential, current and electric field will linearly follow the mechanical pulse. The electric field will therefore propagate as an ordinary EM signal through the earth or through the air in accordance with Maxwell's equations. Representing the source function may be difficult but a collection of electrical dipoles is often effective as a function for any distributed source.

The PZ constants (δ) are material-dependent but a listing of some common ones is given in Neistadt et al, (2006) and Volarich and Sobolov, 1969). In general, quartz bearing materials have coupling values from 1-100×10⁻¹⁴ C/N (Coulomb/Newton), whereas other materials range from zero to 1×10⁻¹⁴. C/N. It is noted that there is often significant variation in the coefficients depending on crystalline structure as well as present and pre-existing stress direction. For example, the coefficients are larger along the maximum extension of (quartz) crystal growth

Sample Calculations

A quartz vein may therefore be mapped using the electrical field generated in response to the mechanical impulse. First, assume a blow from a 10 Kg hammer, striking a target at a velocity of 10 m/s. The blow is presumed to last 10⁻³ s (1 millisecond). The force is therefore (10 kg×10 m/s)/(0.001s) ˜1×10⁵ Newtons. Assuming a constant for a quartz vein of 10⁻¹² C/N and using Eq. (1) the charge calculated for a quartz vein may be approximately 10⁻⁷ C. This charge is generated in 10⁻³ s, so the instantaneous current is calculated as 10⁻⁴ amperes. The strength of the source is calculated as the dipole moment, or the product of the current times the effective dipole length. Here we assume a length of 1.0 m, so that the moment is 10⁻⁴ A-m.

Assuming the electric charge source is represented by a vertical electrical dipole one can calculate the electrical field distribution at the surface. Here it is assumed that the moment is 1 and that the measurements are made over a hard rock having electrical resistivity of 1000 ohm-m as a half-space and scale the response to match the calculated current and background. This may be performed using a 1D electromagnetic modeling program. (See, e.g., U.S. Pat. No. 5,841,280 issued to Yu et al., U.S. Pat. No. 7,340,348 issued to Strack or Berg, 2008) Here a frequency of 1,000 Hz was used and calculated against offset on the surface. The resulting radial distribution of the electric field is shown in FIG. 3. The field amplitude strongly decays with increasing distance from the electric charge source from more than 100 millivolts at a distance of 1 m to a few nanovolts/m at a distance of 50 m. The actual hammer source is 10⁻⁴ times smaller and the measurable electric field is roughly 1-10⁻⁵ mV/m, therefore, a practical limit for the hammer source may be only about 10-20 m.

The surface electrical field from the piezoelectrically induced electric charge source has 1/r³ dependence in the earth, with the field quickly decaying with increasing distance from the source (but not up the borehole). A distributed source and/or an inhomogeneous background would likely change the amplitude distribution to some extent. In addition, if detected signal is due to a seismo-electric conversion, where a seismic wave generates the electromagnetic (EM) field rather the initial impact, the received amplitude will scale with respect to the size of the charge source and the duration of the impact. An actual piezoelectric-induced electric field from a source is shown in FIG. 5 (Volarich and Sobolov, 1969). The foregoing authors suggested that the true event occurred 2 m below the surface where the rock type changed, it is therefore a conversion. Note the almost simultaneous arrivals of the events, also suggesting that this is a direct PZ-induced field, or a conversion, from a nearby seismic event. The size of the PZ-induced field is roughly in line with what is plotted in FIG. 4 although the amplitude decay with offset is less that the dipole field of FIG. 4, again suggesting a seismic conversion rather than a direct PZ-induced electromagnetic field.

For a drilling unit a force is much larger than the example hammer, is applied over a broader area than a hammer source. A typical rotary hard rock drill rig can apply about 5,000 lbs/in² at the bit from the top drive. When averaged over a square meter this becomes roughly 1×10⁸ Newtons (100 megaPascals). Assuming a 5 cm inch quartz vein and a current shut off in ˜1 millisecond would result in a current of roughly 10 A, about 1000 times as large as the example hammer source described above. This suggests that the graph in FIG. 4 would be scaled up by a factor of 10000 (at least) and the signal some 20 meters away would be about 0.5 millivolts over a 5 m measuring length.

### SUMMARY

A method for identifying piezoelectric minerals in a subsurface rock mass according to one aspect of the disclosure includes drilling the rock mass using a drill bit or hammer capable of generating seismic waves by breaking the rock mass. Electrical and seismic signals are detected at a spaced apart location from the drilling. The piezoelectric minerals are detected using the detected electrical signals and the detected seismic signals.

In some embodiments, the electrical signals comprise voltages induced in at least one wire coil.

In some embodiments, the seismic signals comprise acceleration or velocity.

In some embodiments, the electrical signals comprise voltages imparted across at least one pair of electrodes.

Some embodiments further comprise mapping the piezoelectric minerals using the detected electrical signals and the detected seismic signals.

Some embodiments further comprise using the detected seismic signals to correct the detected electrical signals for motion of sensors used to detect the electrical signals.

Some embodiments further comprise using the detected seismic signals and the detected electrical signals to determine background electrical noise and background seismic noise in zones of the rock mass having substantially no piezoelectric minerals, and using the background electrical noise and background seismic noise to correct the detected electrical signals and detected seismic signals noise in zones of the rock mass having substantially the piezoelectric minerals.

Some embodiments further comprise choosing a length of a continuous electrically conductive part of a drill string used to operate the drill bit or hammer to amplify electrical signals having a selected frequency.

Some embodiments further comprise detecting electrical signals induced in a drill string used to operate the hammer or drill bit, and using the detected current to infer the presence of piezoelectric minerals in the rock mass during drilling thereof.

Some embodiments further comprise using the identified piezoelectric minerals and a measurement related to crystal structure thereof to determine presence of at least one precious metal in the rock mass.

An apparatus for determining piezoelectric properties of a rock mass during drilling according to another aspect of this disclosure includes an acceleration sensor operably coupled to a drill string operated by a drilling rig to drill a wellbore in the rock mass. An electric signal sensor is disposed at the surface of the rock mass. A processor is in signal communication with the acceleration sensor, and the electric signal sensor. The processor has instructions thereon to determine the piezoelectric properties, wherein the processor also has instructions thereon to correlate signals from the electric signal sensor with measurements from the acceleration sensor.

Some embodiments further comprise a toroid coil sensor disposed about the drill string and in signal communication with the processor. In such embodiments, the processor has instructions thereon to indicate presence of piezoelectric materials in the rock mass from signals generated by the toroid coil sensor.

Some embodiments further comprise an electric current sensor or voltage sensor disposed along the drill string and in signal communication with the processor. In such embodiments, the processor has instructions thereon to indicate presence of piezoelectric materials in the rock mass from signals generated by the electric current sensor or voltage sensor.

An apparatus for determining piezoelectric properties of a rock mass during drilling according to another aspect of the disclosure includes an acceleration sensor operably coupled to a drill string operated by a drilling rig to drill a wellbore in the rock mass. A seismic sensor and an electric signal sensor are disposed at the surface of the rock mass. A processor is in signal communication with the acceleration sensor, the seismic sensor and the electric signal sensor. The processor has instructions thereon to determine the piezoelectric properties, wherein the processor has instructions thereon to correct signals from the electric signal sensor for motion and background noise using measurements from the acceleration sensor and the seismic sensor.

Some embodiments further comprise a toroid coil sensor disposed about the drill string and in signal communication with the processor. The processor in such embodiments has instructions thereon to indicate presence of piezoelectric materials in the rock mass from signals generated by the toroid coil sensor.

Other aspects and advantages will be apparent from the description and claims that follow.

### BRIEF DESCRIPTION OF THE DRAWINGS

FIG. 1 shows schematically how mechanical stress generates electrical potential in a piezoelectric material.

FIG. 2 illustrates a direct piezoelectric field induced by an impact.

FIG. 3 shows a radial distribution of the electric field in FIG. 2.

FIG. 4 shows a graph of an electrical field from a vertically oriented piezoelectric source with a moment of 1

FIG. 5 shows a graphic display of electric field measurements from a piezoelectric source.

FIG. 6 shows an example embodiment of a drilling unit and a measurement array.

### DETAILED DESCRIPTION

This disclosure sets forth a method for characterizing the piezoelectric properties of materials being drilled by a drilling system including a rig, drill string and drill bit, where drill bit interactions with the formation being drilled generate an electromagnetic field. This field is detected by one or more sensors located in the vicinity of the drilling system.

The drill bit impacts on the formation crack the rock. The cracking creates an electric dipole impulse-like signal at the bit/rock interface, where the amplitude is in the millivolt range and the frequency is roughly centered at 1 Mhz. The properties of the impulse-like signals wavelet are affected by the electromagnetic properties of the rock.

The crack-generated electric dipole impulse-like signal travels away from the interface into the formation, up the wellbore in the air or fluid in the wellbore, and through the drill string. 1 Mhz is in the low frequency radar regime, where the wavenumber is complex. The wave propagation component is attenuated by the properties of the propagation medium. Air or fresh water, having a low electrical conductivity, are less attenuating than a conductive formation or the steel drill string. Consequently, the signal traveling along the air or fluid path up the wellbore is the most energetic signal received at the surface. One or more electromagnetic or electric field sensors, e.g., radar antennas, in some embodiments tuned to this frequency range. can be used to detect the electric dipole impulse-like signals at the surface. These antennas can be attached at selected locations on and around the drill rig to improve the signal quality.

The sensor response may be affected by noise from seismic signals propagating from the drill bit or from other acoustic/seismic sources in the vicinity of the drilling system. Signals from collocated seismic sensors may be used with suitable data processing to remove this noise from the signals detected by the electromagnetic sensor(s).

An Example Implementation

A method according to the present disclosure includes an operating drilling system including a rig, drill string and drill bit, and using the drill bit impacts on the formation as a piezoelectric energy source and collecting EM data during drilling. A sensor or sensors is located in the vicinity of the drilling system to detect the piezoelectrically induced signals resulting from the bit impacts on the formation.

As shown above, in background formations (rock) that do not contain significant amounts of PZ material such as quartz, the PZ coefficients are very small and there will be a minimal electrical field associated with drilling induced seismic energy. In quartz or other high coefficient materials, however, the induced electric field can be substantial and can be measured with the sensor(s).

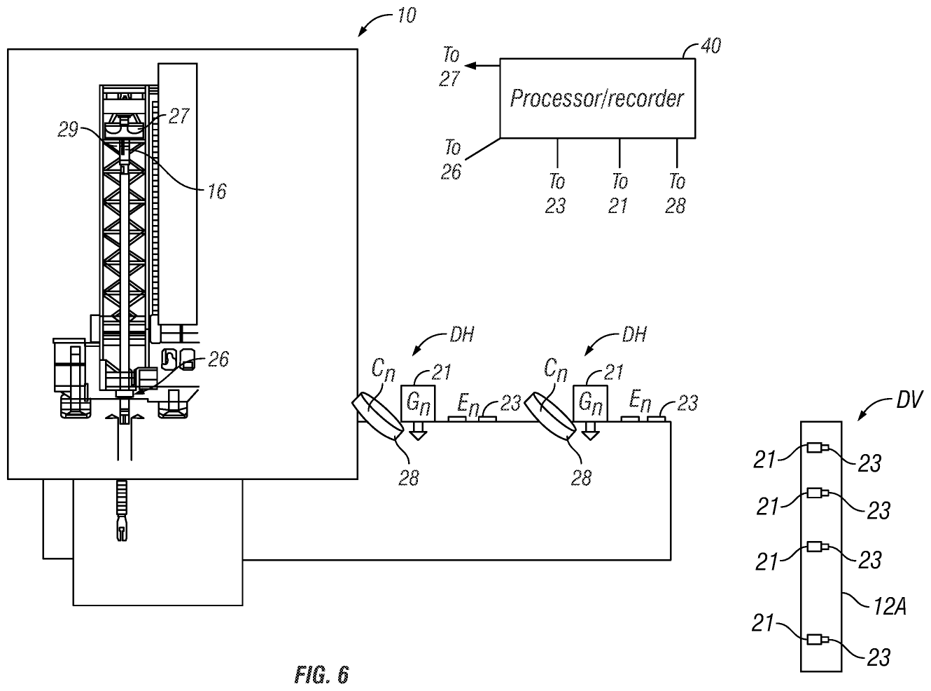

FIG. 6 illustrates an example embodiment of an apparatus and method. A rotary or hammer based rig 10 is shown drilling a wellbore 12 into a rock mass 14. The rig 10 may be powered by a diesel motor that converts fuel energy into mechanical hammer or rotary drill bit 15 motion; in some embodiments an electrically powered rig can also be used. The rotary bit or hammer 15 motion may be recorded by an accelerometer 16 located adjacent to a drill string 18 (a length of pipe and tools used to operate the hammer or drill bit 15) used to drill the rock mass 14.

Within the wellbore 1212 during drilling, the drill bit or hammer 15 is applying mechanical stress to the rock mass 14 at the rock/bit interface, point B, which will (eventually) fracture and/or pulverize the rock mass 14 in contact with the hammer or drill bit 15. The mechanical stress imparted by the hammer or drill bit 15 generates shock or seismic waves C near the hammer or drill bit 15, which shock waves C propagate within the adjacent rock mass 14. These shock waves may C be measured by sensors 21 in a horizontal sensor array DH disposed in a selected pattern on the ground surface and/or in a vertical sensor array DV disposed in an adjacent well 12A. At point A the shock waves C are converted to electrical current in the presence of a PZ material 20, e.g., a quartz vein.

If the shock (seismic) waves C encounter a PZ material 20, e.g., a quartz vein, then some of the mechanical energy will be converted to electrical energy at the material interface. This electrical energy will travel at the propagation velocity of an electromagnetic wave in the rock mass 14 and will arrive at either sensor array DH, DV much sooner than the corresponding shock or seismic waves C (generated by the same mechanical energy imparted by the hammer or drill bit 15), although the seismic waves C will have similar amplitude with respect to time characteristics to the electromagnetic wave. Note that only the mechanical energy (in the form of the seismic waves C) that encounters the PZ material 20 (e.g., the quartz vein) will induce electrical signals in addition to seismic signals. As used herein to describe the PZ signals generated by mechanical stress applied to the rock mass 14 “electrical” means an impressed voltage, electromagnetic wave or both. Such signals may be detected by either galvanic sensors (spaced apart pairs of electrodes), electromagnetic sensors, magnetometers or combinations of the foregoing. Examples of such sensors will be described further below.

During the drilling operation, electrical and seismic signals are measured by either sensor array DH, DV. These signals comprise drilling and background electrical and mechanical noise in addition to seismic and EM signals indicative of PZ material targets. Sensors in the sensor arrays DH, DV may comprise seismic sensors 21, e.g., geophones, and/or accelerometers. The accelerometer 16 provides signals corresponding to the drilling stress, which is directly related to seismic and electrical signals transmitted into the rock mass 14 from the hammer or drill bit 15. Electrical sensors 23, which may be wire coils or electrode pairs, detect the electrical signals generated at the interface and propagated through the rock mass 14. Wire coils or magnetic field sensors, shown generally at 28 may be included in the sensor array(s). An electric current sensor 26, for example a toroidal coil, may be disposed about the drill string 18 to detect current flowing along the drill string 18. A voltage sensor 27 may be connected across an electrical isolator 29 disposed in the drill string 18 to detect voltages induced in the drill string 18.

A processor/recorder 40, which may be any form of microcomputer, field programmable gate array, controller or similar signal processing and recording device may be in signal communication with all of the foregoing sensors and may have programmed thereon instructions to carry out signal processing to be further described below.

Data processing workflow to be performed on the processor/recorder 40 or any other processor or computer may be designed to provide a quartz/no quartz indicator on depth-related segments of the wellbore 15 as it is being drilled.

The measured seismic signals (detected by electrical sensors 21) from the accelerometer 16 may be convolved, e.g., in the processor/recorder 40, with the seismic and electrical signals (detected, respectively by seismic sensors 21 and 23/28) in order to isolate drilling-induced PZ signals from background noise. The isolated electrical and seismic signals are related to the PZ and seismoelectric characteristics of the rock mass 14 being drilled. The time signature of these isolated signals may then be used to map the structure of a PZ mineral body such as the quartz vein 20, if desired, using simple straight-ray tomography or other imaging techniques known in the art

Piezoelectric signals may be created by distinctly different mechanisms. Rock fracture will generate and propagate high frequency PZ signals, of the order of megahertz and strain waves from the hammer or drill bit 15 will generate and propagate PZ signals at lower frequencies, of the order of tens to thousands of hertz.

The drill string 18 will act as an antenna for EM signals that have a wavelength equivalent to the wavelength of the propagated PZ signals, or a factor or fraction of such wavelength. For example for a 3 MHz PZ signal will excite a resonant signal that will be amplified in a 10 m drill string as this length is equal to ¼ wavelength of the PZ signal. The properties of the drills string will enhance the transmission of certain frequencies and improve signal to noise ratio at the sensors. In some embodiments, the electromagnetic sensors, e.g., sensors 23 and 28, may be tuned to have increased sensitivity to signals that are whole number multiples of ¼ wavelengths of the drill string length.

To enhance the electrical signals measured relating to the drill pipe apparatus may be used to effectively electrically insulate the drill pipe from electrical grounding to the rig, such that the voltage signal induced in the drill pipe is maximized. This signal can be measured directly as a potential difference, or via a radio frequency signal or capacitive sensor.

In other embodiments, to enhance the electrical signals measured relating to the drill pipe apparatus may be used to effectively electrically connect the drill pipe to an electrical ground at the top of the drill pipe to the rig, such that the current signal induced passing up the drill pipe is maximized. This signal can be measured directly as a current, or remotely sensed as a coil.

To those practiced in mining geology, there are known correlations and relationships between quartz content, distribution and crystal structure and the presence of precious minerals and metals. The resulting signals relating primarily to quartz content and crystal structure may be used to derive relationships between rock types and the presence of valuable minerals in the rock mass 14, including but not limited to gold, silver, copper and platinum using empirical relationships derived from measurements of ore grade from analysis of drill cuttings or other measurements. These may be generated by machine learning methods and algorithms such as artificial neural networks. In this case the combination of drill cuttings geochemical measurements and the piezoelectric measurements would provide a training dataset for said machine learning methods. Subsequently the trained machine learning algorithms would be used to estimate the ore grade from the piezoelectric measurements alone.

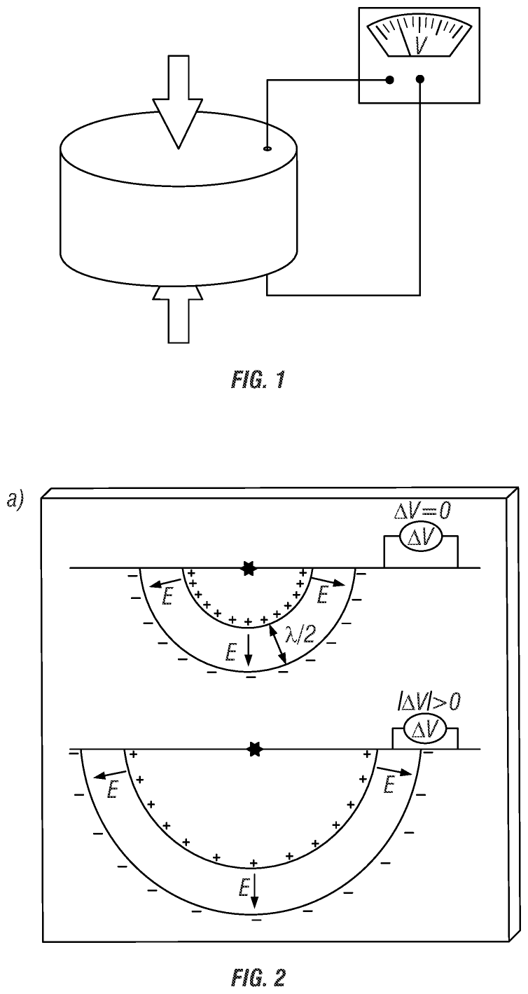

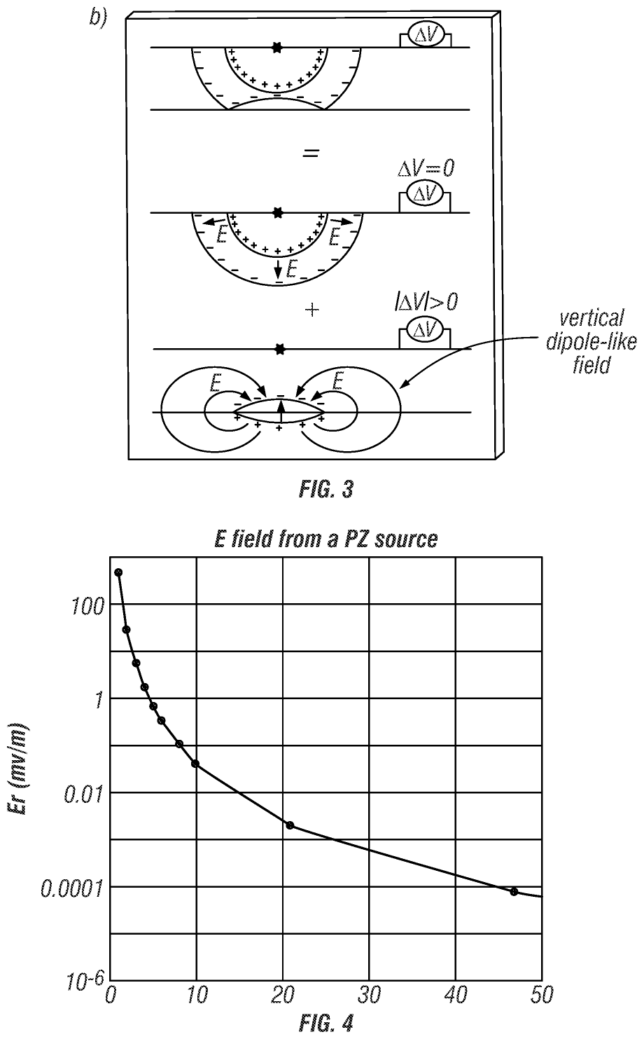

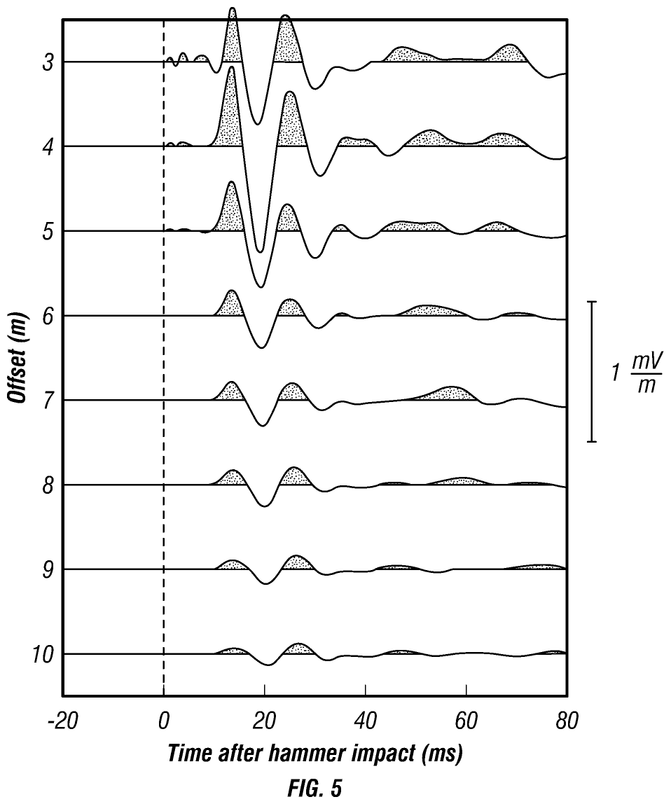

Piezoelectric signals, as explained above, travel near electromagnetic propagation speed in the rock mass (14 in FIG. 1) and can be considered to arrive without delay compared to seismic signals which at the , e.g., 28 and 23, travel at the velocity dependent on rock mass elastic properties. A seismic signal recorded, in a preferred embodiment, and will arrive at the top of the drill string could be correlated with seismic sensors 21 with the EM signals recorded by corresponding time delay relative to the sensor or sensors to identify and enhance the EM signals created by the bit impacts.

Under ordinary drilling operation within normal background (e.g., no PZ minerals in the rock mass 14) the drill string 18 will carry electrical currents related to grounding currents from drilling operations. If, however the drill bit or hammer 15 encounters a quartz vein or other PZ mineral body, then the measured current along the drill string 18 will be different, likely somewhat larger, due to the connection to piezoelectric material in the wellbore 12. In some embodiments, a toroid coil 26,may be disposed around the drill string 18, to measure electrical currents within the drill string 18. Such measurements may be used as a quick indicator for the presence of PZ minerals within the wellbore 12.

A galvanic voltage or current sensor 27 may be disposed across the shock sub (e.g., isolator 29) to measure a parameter related to current flow along the drill string. In this example, the drill string would be electrically connected to the rig mast by the sensor 27. It may also be possible to measure the potential difference between the drill string pipe and the drill itself (mast/chassis) if the shock sub is an electrical insulator (e.g., isolator 29). In this case the drill string 18 would be insulated from the rig mast. Voltage and/or current measurements made by the foregoing sensors 27, 26 may be conducted to the processor/recorder 40 for analysis as to presence of PZ minerals in the rock mass 14.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A method for determining piezoelectric properties of a subsurface rock mass, comprising:
drilling the rock mass using a rotary drill bit or hammer drill capable of generating piezoelectric signals by applying stress to the rock mass at the drill bit;
detecting electrical signals at one or more locations; and
determining the piezoelectric properties of the rock mass using the detected electrical signals.

2. The method of claim 1 wherein the electrical signals comprise voltages induced in at least one wire coil.

3. The method of claim 1 wherein the electrical signals comprise voltages imparted across at least one pair of electrodes.

4. The method of claim 2 further comprising using a geophone or accelerometer disposed proximate to the wire coil to detect vibration signals, and using the vibration signals to correct the detected electrical signals for motion of sensors used to detect the electrical signals.

5. The method of claim 1 comprising an accelerometer attached to the drill string detecting seismic signals from an accelerometer correlating the detected seismic signals and electrical signals to determine the piezoelectric properties of the rock mass.

6. The method of claim 1 comprising detecting seismic signals from the rock mass and correlating the detected seismic signals and electrical signals to determine seismic or elastic properties of the rock mass.

7. The method of claim 1 further comprising using the detected seismic signals and the detected electrical signals to determine background electrical noise and background seismic noise in zones of the rock mass having substantially no piezoelectric minerals, and using the background electrical noise and background seismic noise to correct the detected electrical signals and detected seismic signals noise in zones of the rock mass having substantially the piezoelectric minerals.

8. The method of claim 1 further comprising choosing sensor frequency to detect frequencies for which the conductive drill string length string acts as an antenna

9. The method of claim 1 further comprising detecting electrical signals induced in a drill string, and using the detected current electrical signals to infer the presence of piezoelectric minerals in the rock mass during drilling thereof.

10. The method of claim 1 further comprising using the identified piezoelectric minerals and a measurement related to crystal structure thereof to determine presence or concentration of at least one precious metal in the rock mass.

11. An apparatus for determining piezoelectric properties of a rock mass during drilling, comprising:
an acceleration sensor operable coupled to a drill string operated by a drilling rig to drill a wellbore in the rock mass;
an electric signal sensor disposed at the surface of the rock mass; and
a processor in signal communication with the acceleration sensor, and the electric signal sensor, the processor having instructions thereon to determine the piezoelectric properties, wherein the processor further has instructions thereon to correlate signals from the electric signal sensor with measurements from the acceleration sensor.

12. The apparatus of claim 11 further comprising a toroid coil sensor disposed about the drill string and in signal communication with the processor, the processor having instructions thereon to indicate presence of piezoelectric materials in the rock mass from signals generated by the toroid coil sensor.

13. The apparatus of claim 11 further comprising an electric current sensor or voltage sensor disposed along the drill string and in signal communication with the processor, the processor having instructions thereon to indicate presence of piezoelectric materials in the rock mass from signals generated by the electric current sensor or voltage sensor.

14. An apparatus for determining piezoelectric properties of a rock mass during drilling, comprising:
an acceleration sensor operable coupled to a drill string operated by a drilling rig to drill a wellbore in the rock mass;
a seismic sensor and an electric signal sensor disposed at the surface of the rock mass; and
a processor in signal communication with the acceleration sensor, the seismic sensor and the electric signal sensor, the processor having instructions thereon to determine the piezoelectric properties, wherein the processor further has instructions thereon to correct signals from the electric signal sensor for motion and background noise using measurements from the acceleration sensor and the seismic sensor.

15. The apparatus of claim 15 further comprising a toroid coil sensor disposed about the drill string and in signal communication with the processor, the processor having instructions thereon to indicate presence of piezoelectric materials in the rock mass from signals generated by the toroid coil sensor.
